(19) United States
(12) Patent Application Publication
(10) Pub. No.: US 2007/0100692 A1
(43) Pub. Date: May 3, 2007

(54) Methods relating to co-packaging occasion-based products

(75) Inventors: Charles David Minifie, Terrace Park, OH (US); John Thomas Cooper, West Chester, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company

(21) Appl. No.: 11/352,895

(22) Filed: Feb. 13, 2006

Related U.S. Application Data
(60) Provisional application No. 60/731,809, filed on Oct. 31, 2005.

(51) Int. Cl. G06Q 30/00

(52) U.S. Cl. 705/14

(57) ABSTRACT

The disclosure provides for a method for increasing the sales of co-packaged occasion-based products. The method uses the steps of: 1. determining an occasion, 2. identifying a consumer need/habit/practice for the occasion, 3. identifying solutions that meet the consumer need/habit/practice, and 4. co-packaging the identified occasion-based products that meet the consumer need/habit/practice into a package.

### PRIORITY

This Application claims priority to U. S. Provisional Application Ser. No. 60/731,809 filed Oct. 31, 2005.

### FIELD OF THE INVENTION

This invention relates to systems and methods for promoting the sale of occasion-based products and more particularly to methods associated with occasion-based products that are co-packaged to provide at least one consumer benefit.

### BACKGROUND OF THE INVENTION

Businesses and corporations that sell and distribute information and/or goods have the ability to sell their products in many different ways. One particular way to sell more than one of the same or different products at the same time is to bundle them together. This is known to those of skill in the art as bundling. Bundling is also known in the trade as co-packaging.

Bundling is presently defined as selling two or more different products together at a single price. Bundling items together gives the unfamiliar consumer the chance to use a product that they would normally not buy as an individual item. Bundling can also provide an opportunity for a company to get new products out into the market. In some cases, consumers may be just looking for one certain game, program, article, etc. For example, if related items are bundled together for a lower price than buying both items separately, then it could persuade consumers to purchase the bundled package. Even if the consumer does not have any plans to use the extra item or items within the bundled package, there is always that slight chance that it could be of some use to them in the future. For example, if the consumer was tired of, or completed a game, then they would be getting more value by playing the other game that was included within the bundle and provided at no, or very little, extra cost to them.

For example, cellular telephone providers usually offer several different service options of what one wants to come with the phone account. Whether it is free voice mail, text messaging, internet access, or the like, these options are bundled together to allow the consumer to choose which option combination best suits their needs. Along with these service options, accessories such as a car charger, hands free handset, or other related items can also be chosen to be included in the personal bundle. The ability to customize the service and options package encourages more people to use the product since they are provided with the option to pick what features they want instead of being limited to a single service and option choice.

Additionally, producers of consumer products may offer all their products separately or may choose to bundle them together. If the producer chooses to bundle the products together, it could result in reduced costs related to packaging, marketing, advertising, and the like. Bundling items together could also reduce the sales costs and in turn, yield higher profits since more people would be willing to purchase the bundle. Bundled products could also gain an advantage over competition offering two or more items for a better price than the price of the competitor's single item. Bundled items can provide for added consumer convenience. For example, a consumer can shop for such bundled items in one aisle of a store rather than have to seek the individual items in a plurality of store aisles or differing store locations.

Bundling can also offer convenience to the consumer by locating related items together. By locating the two or more products together in a bundle, the consumer avoids the need to locate within the store the individual items, each at their own individual location. This not only saves the effort of locating the items but also the time required to move to each individual product location.

This convenience can also be translated into the at-home experience for the consumer. If the products are purchased as a bundled package, there is a higher probability that the items will remain close to each other in the home thereby making it easier to locate them for current, or future, use.

Typically, co-packaged items, such as those discussed supra, are produced and packaged on a task-based basis. One should understand that a task-based opportunity provides for a specific piece or amount of work that is often required or expected to be finished within a certain time. In other words, tasks that require completion are done within the same time-frame. Such task-based opportunities may include such common examples as brushing teeth, providing for daily hygiene, sporting events, child care, food preparation, and the like. Such co-packaged, or bundled, articles that address such task-based opportunities usually are provided with a thematic tie. In other words, task-based promotions may comprise two or more products that are inherently linked in common usage. For example, it is common to provide a carton of toothpaste in combination with a toothbrush in order to accomplish the task-based opportunity of brushing one's teeth. Likewise, exemplary co-packaged articles providing a razor, shaving cream, shampoo, toothpaste, toothbrush, anti-perspirant, and a comb, can provide all of the articles required to, accomplish basic daily personal hygiene. Additionally, an exemplary co-packaging of a football ‘tee’ and an air pump may be suitable for the task-based work of providing for participation in a sporting event, or activity, such as a football game. Similarly, providing a co-packaged, or bundled, article comprising diapers and wet wipes may be suitable for the task-based work of providing for basic child care. Similarly, bundling a container of glass cleaner with a roll of paper towels could be suitable for cleaning windows. In any regard, task-based article bundling is strictly focused on providing the implements required to accomplish a particular task or series of tasks.

However, such task-based article bundling does not facilitate the marketing of co-packaged articles for occasions. Occasion-based co-packaging provides articles for a circumstance, occurrence, or state of affairs that provides grounds or reasons for something to happen. Such occasion-based packaging would allow for the beneficial co-packaging of compositions and/or articles that are typically not packaged in one standard container. Additionally, such occasion-based co-packaging of articles could facilitate and/or provide for the establishment of business relationships that have been heretofore unrealized.

### SUMMARY OF THE INVENTION

The present invention provides for a method for increasing the sales of co-packaged occasion-based products. The method comprises the steps of: 1. determining an occasion, 2. identifying a consumer need/habit/practice for the occasion, 3. identifying occasion-based products that meet the consumer need/habit/practice, and, 4. co-packaging the identified occasion-based products that meet the consumer need/habit/practice into a package.

The present invention also provides for method for increasing sales of co-packaged occasion-based products. The method comprising the steps of: 1. identifying a consumer need/habit/practice for an occasion, 2. identifying solutions to meet the consumer need/habit/practice, and, 3. co-packaging the identified solutions that meet the consumer need/habit/practice for said occasion into a package.

### BRIEF DESCRIPTION OF THE DRAWINGS

FIG. 1 is a flow-chart depicting an exemplary process for co-packaging occasion-based products according to the present invention; and,

FIG. 2 is a flow-chart depicting an exemplary manufacturing process for co-packaging occasion-based products where dashed lines represent optional steps.

### DETAILED DESCRIPTION OF THE INVENTION

As used herein, the various forms of “comprise,” “have,” and “include,” are to be considered legally equivalent and are open-ended. Therefore, additional non-recited elements, functions, steps, or limitations may be present in addition to the recited elements, functions, steps, or limitations.

As used herein, an “occasion-based effort” or an “occasion-based opportunity” is a circumstance, occurrence, or state of affairs that provides grounds or reasons for something to happen. In other words, there is no need to provide for the completion of the steps comprising the occasion within a given time-frame or geography. Exemplary, but non-limiting, occasion-based occurrences include illnesses, the occurrence of environmentally-triggered allergies, party planning, tail-gate partying, weddings, evenings out, picnics, baptisms, funerals, graduations, vacations, holidays, combinations thereof, and the like. As contrasted with a task-based effort or task-based opportunity, an occasion-based effort or an occasion-based opportunity is typically non-synergistic in its function, form, or presentation. This could include shopping for items typically to be located within a single room. An occasion-based effort or an occasion-based opportunity may or may not include one or more task-based efforts.

As used herein, “substrate” is a flexible sheet, web material, or web segment that may be useful for household chores, personal care, health care, food wrapping, cosmetic application or removal, and the like. Non-limiting examples of suitable substrates useful for the present invention include non-woven substrates, woven substrates, hydro-entangled substrates, air-entangled substrates, paper substrates such as tissue, toilet paper, or paper towels, waxed paper substrates, co-form substrates, wet wipes, film or plastic substrates such as those used to wrap food, metal substrates such as aluminum foil, and combined substrates such as diapers, feminine care products, and the like. Furthermore, laminated or plied together substrates of two or more layers of any of the preceding substrates are suitable for use with the present invention.

As used herein, a “task-based effort” or a “task-based opportunity” is a specific piece or amount of work that is often required or expected to be finished within a certain time.

One of skill in the art will understand that consumers create shopping lists, and then shop at stores, based on specific tasks around the home or in their community. Numerous manufacturers and retailers of consumer goods have made use of this insight by creating task-based promotions to address the needs of the task-based effort or opportunity. Such task-based promotions may include co-packaging of items designed to accomplish that designated task by utilizing the items in synergistic fashion.

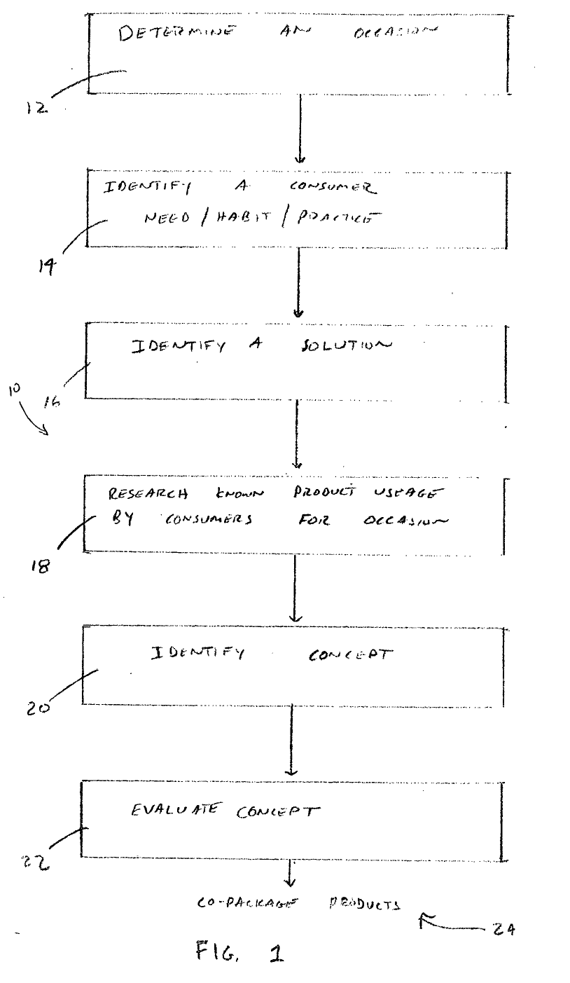

Referring to FIG. 1, one of skill in the art will appreciate that consumers also plan and execute shopping trips based upon an occasion. Thus, it would be beneficial for producers of consumer goods, and other consumables to increase their sales by co-packaging such occasion-based products for these occasions. Such a process for increasing the sales of co-packaged occasion-based products is represented by the numeral 10. A selected, or determined occasion 12 may be a group of several simple tasks or may even comprise a broader event that requires disparate items and activities provided in a pre-determined sequence or in a random sequence to fulfill the requirements of that occasion. As such, occasion-based promotions and occasion-based bundles preferably comprise two or more products that are not commonly linked in everyday usage.

However, it was surprisingly found that when such occasion-based products are used in concert, they create a unique benefit solution for an identified problem or need. By way of non-limiting example, such a unique benefit solution can provide a heretofore unseen convenience to the consumer such as providing a convenience of purchase. In this example, a consumer would only need to make one stop to pick up disparate groups of products. In another non-limiting example, the convenience to the consumer can be provided in the way the articles are packaged. In this example, depending on how the products are packaged, integrated products can be located in one spot together—there is no need to search for other products associated with the desired occasion-based task.

Exemplary occasions suitable for use with the present invention, in addition to those occasions described supra, can include cold season, influenza season, allergy season, back-to-school season, entertaining, recreation, and the like. It should be understood by one of skill in art that the occasions presented, are exemplary in nature. One of skill in the art should fully understand that a potentially endless list of occasions suitable for use with the present invention could be successfully used with such co-packaged occasion-based bundled products.

Next, a consumer need/habit/practice as related to the occasion is determined 14. In an exemplary, non-limiting embodiment commensurate in scope with the present invention, one of skill in the art would realize that such a determination could be conducted by large-scale omnibus quantitative (i.e., greater than 300 respondents) studies to determine the need/habit/practice within a known business category. Such a study could identify various product uses for an/the identified occasion. Typically, an exemplary need/habit/practice study is conducted by providing a multi-page questionnaire to determine product usage by the consumer. By way of non-limiting example, within the general category of facial tissue, a consumer may identify the use of a facial tissue for the uses of blowing the nose, removing facial cosmetics, blotting lipstick, clotting blood on small cuts or nicks, wiping up small spills, and the like.

As required, in order to gain a greater understanding of the desired uses, and the context in which they may occur, one of skill in the art could then optionally conduct follow-up qualitative studies, (i.e., between one and one hundred respondents). In a non-limiting embodiment, such studies may occur in a respondent's home, in stores, in a focus-group facility, other research facilities, and the like. The respondents may be questioned about their use of such products as well as by visual observation of how these products are actually used by the consumer.

By analysis of the results of any quantitative and a qualitative studies conducted as described herein, a hypothesis can be created to determine the occasions that will set the stage for the specific occasion-based material or consumer product use involved. By way of non-limiting example, if the product to be marketed comprises facial tissue, the use of a facial tissue as related to the use of blowing the nose may have a large occasion associated thereto that drives the need for this usage. Such occasions may include, but not be limited to, contracting a cold, contracting the flu, suffering from allergies, waking up in the morning with a stuffy nose, and the like.

Third, solutions that meet the consumer need/habit/practice are identified 16. Typically, such solutions are identified by initially researching a known product or item usage by the consumer as related to the occasion at hand as would be done by one of skill in the art.

Such research to further explore broad solutions for these occasions can now be studied 18. This provides for the surprising result that rather than just providing focus on the better delivery of products that meet the need of the usage, the broader solution can be applied to the selected occasion. By way of example, if a consumer is suffering from the flu, numerous symptoms other than blowing your nose may require treatment for the affected consumer. These symptoms may be addressed and/or remediated by various occasion-based remedies as an identified concept 20. By way of non-limiting example, consumers suffering from the flu may need a variety of products in order to accomplish several tasks associated with that occasion. Within the occasion of treating the symptoms of the flu, such products may comprise, but not be limited to, facial tissue, chicken soup, a humidifier, cough drops, a sports drink, water, hand cleansers, laundry detergent, disinfectant, medicaments, and the like. These concepts are identified in order to meet the consumer need/habit/practice for the desired occasion.

Next, the concepts identified 20 are evaluated in order to provide for their efficacy 22. Based upon the possible solutions identified for the desired occasion, further rounds of consumer research may be conducted, by techniques known to those of skill in the art, to determine what the selected offering should be to best meet the consumer need for the occasion. One of skill in the art will understand that such consumer research can be conducted by concept screeners or by additional qualitative feedback. However, it should be realized that other types of consumer research may be conducted and yet remain within the scope of the instant invention.

For example, if a concept screener method is employed to conduct the additionally required consumer research, such a process could create several one page concepts that include a description of the desired items for the occasion, and provide for the benefits to the provision of such items for the occasions, and the costs associated therefore. By the screener using several concepts, relative to a control, and using a base of approximately 100 to 300 respondents, one of skill in the art could quickly assess the viability of the identified solution for the selected occasions.

In the case of small-based qualitative feedback, the utilization of fewer respondents (i.e., approximately 4 to 24 respondents) may provide for the opportunity to describe the options within the context of a focus group or other similar setting. Such a setting may provide for more direct feedback on the options addressed for the desired occasions. One of skill in the art would utilize such a setting to provide the prediction of a viability of the overall proposition.

Additionally, one of skill in the art could measure the overall sales potential of the options for such an occasion-based co-package upon the consumer perception of the value. Such perceptions may be reported back to the researcher via a questionnaire and may include the consumer's willingness to purchase the product offering for the given occasion. Additionally, the consumers, or respondents, overall reaction based upon the questions within the study can be utilized to measure a perception on the overall concept, as well as the favorability of the concept, the consumer's assessment of the value of the concept, and the like. However, one of skill in the art will understand that a plurality of overall reactions based upon the questions associated with the concept of the occasion-based solution can be utilized in order to provide any required market assessment.

In a preferred embodiment, the selected occasion-based products are co-packaged 24 in order to provide for a solution to the concept previously identified. It is believed that such co-packaging of two or more products that are not commonly linked in everyday usage but provide for the solution to an occasion-based situation, can provide for an increase in sales of both co-packaged items and to provide for the greater convenience of the consumer.

A first item, product, or article is selected from a first plurality of exemplary items to be co-packaged and can include disposable absorbent products such as paper towels, facial tissues, sanitary tissues, and the like, such as would be made from one or more webs of tissue paper. In addition, a first item selected from a first plurality of exemplary occasion-based products can comprise polymeric films, trash bags, hand towels, metal foils, such as aluminum foil, wax paper or grease-proof paper, polymeric films, non-woven webs, fabrics, combinations thereof, and the like. Such materials can be useful in dealing with occasion-based situations such as cold season, flu season, and allergy season.

In addition to the occasion-based products described supra, such products can be co-packaged with a second item, product, or article selected from a second plurality of exemplary items suitable for a wide variety of occasions. By way of non-limiting example, facial tissues can be co-packed with a hand sanitizer in order to provide for an occasion-based situation in dealing with the common cold. In the past, it is unlikely that such items as a facial tissue and hand sanitizer would be co-packaged. Likewise, during cold season, one of skill in the art would be able to co-package a facial tissue with a known cough suppression formula or other medicament such as Vicks Formula 44D, manufactured by the Procter & Gamble Company, Cincinnati, Ohio. Similarly, during cold season, facial tissues may indeed be co-packed with a known home remedy such as chicken soup in order to provide for a known folk remedy to the cold symptoms as well as provide for a known need in dealing with the common cold.

Additionally, the occasion-based situation of spring allergy season can provide for a co-packaging of facial tissues with an anti-histamine product or medicament. Such an anti-histamine product or medicament may provide relief for the symptoms related to the allergy and the facial tissue provided therefore can provide for relief to the known runny nose.

Further non-limiting examples of occasion-based co-packaging can include:
1. Co-packaging a facial tissue with a digital video disk (DVD). If the DVD is provided with a medium of entertainment that is known to provide, or elicit, an emotional response, the facial tissue can provide a convenient method to accommodate such response.
2. Co-packing a facial tissue with a discount coupon for a theatrical performance. If the theatrical performance is provided with a medium of entertainment that is known to provide, or elicit, an emotional response, the facial tissue can provide a convenient method to accommodate such response.
3. Co-packing a facial tissue with a bag of rice. After a wedding, it is customary to throw rice upon the newly married couple. Since weddings are known to provide, or elicit, a known emotional response, the facial tissue can provide a convenient method to accommodate such response.
4. Co-packaging a facial tissue or other absorbent product with a rain-repellant covering. During inclement weather, particularly at a sporting event, it may be necessary, and appropriate, to wear such a rain-repellant covering. Prior to taking a seat, it would also likely be advisable to use a facial tissue or other absorbent product to clean the area proximate to where the user plans to sit.
5. Co-packaging a facial tissue or other absorbent product with a cap or other head covering. During warm weather, particularly during participation in a sporting event, it may be necessary, and appropriate, to wear such a cap or other covering. During the event, it may be necessary to wipe sweat from ones forehead with the absorbent article.
6. Co-packaging a tissue napkin or other absorbent product with foodstuffs. During the observance of a sporting event at home (such as the Super Bowl), it may be necessary, and appropriate, to cover an eating surface with a napkin tissue or other absorbent product. This may be useful in preventing the dirtying of the eating surface with the foodstuffs during a particularly exciting portion of the event.
7. Co-packaging non-perishable foods items with a disposable garbage bag for picnics or tail gating parties at sporting events. This combination would provide benefit during the party and providing for quick disposal of all used and waste items after the party
8. Co-packaging a disposable camera with facial tissues and/or other absorbent products for joyous occasions such as graduations, weddings, or baptisms.
9. Co-packaging new school supplies with facial tissues and/or other absorbent products for the first day of the new school year.
10. Co-packaging specific room-based products such as facial tissues and/or other absorbent products with fixture cleansers.

### PROCESS

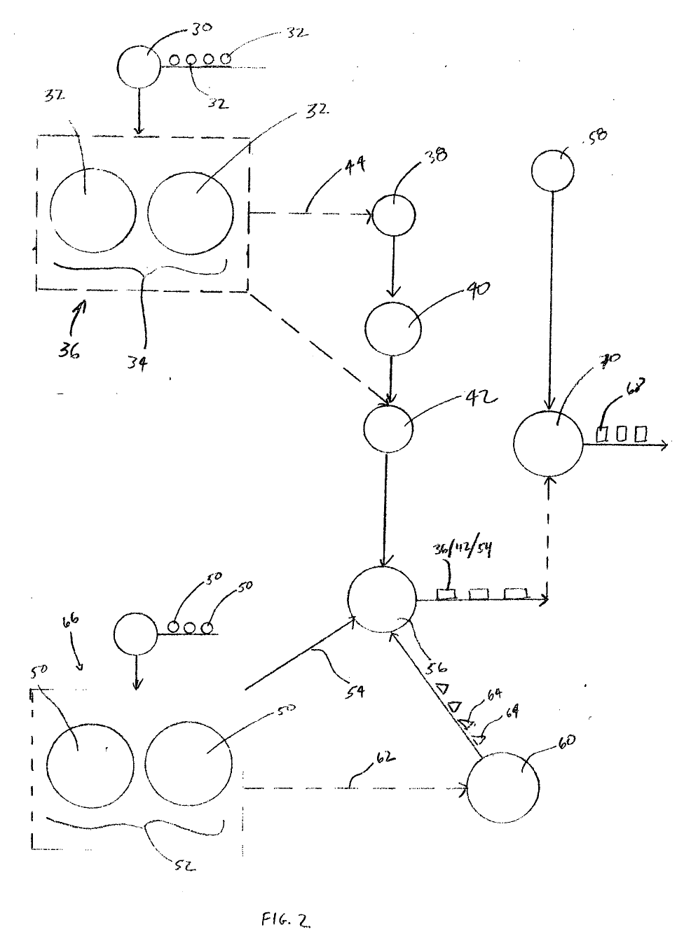

Referring to FIG. 2, by way of example, an initial packing system 30 can provide for an initial package of an initial type of article 32 for any occasion-based opportunity. Any type of automated assembly mechanism can include or otherwise cooperate with such an initial packing system 30. Accordingly, the operative combining of a first plurality of articles 34 can include or otherwise cooperate with the initial packing of the initial type of article 32 that provides for the initial package 36. Further, and optionally, the first plurality of articles 34 can be moved into a first packing system 38 to provide a first package 40. The first package 40 can then be operatively secured to the initial package 36 to provide a first combined-package 42.

One of skill in the art would realize that a first transport device 44 could be configured to move the first plurality of articles 34 into the first packing system 38 that then can operatively provide the first package 42 of the first plurality of articles 34. Additionally, the assembly mechanism can be configured to operatively secure the first package 42 to the initial package 36. Accordingly, the first package 42 and the initial package 36 can be bundled to provide a desired combined package 42. In a particular aspect, a first supplemental transfer device can be configured to move the first plurality of articles 34 into the first packing system 38 to provide the first package 42of the first type of articles 34.

Such a co-packing apparatus can further include providing a second plurality of a second type of individual articles 50 with the second type of articles 50 differing from the first type of articles 34 in order to provide for the occasion-based situation. A particular aspect can include a second accumulator system that can be automated to provide the second plurality 52 of the second type of individual articles 50. The second type of articles 50 may differ from either or both of the initial type of articles 34 and the first plurality of articles 34 as desired. A second transport device 54 can move the second plurality of articles 52 to a second packing location 56 and the assembly mechanism can be further configured to operatively combine the second plurality of articles 52 with the initial plurality of articles 42.

Alternatively, a second supplemental transfer device 62 can then be configured to move the second plurality of articles 52 into a second packing system 60 that can provide for a third package of a third type of articles 64. Additionally, the assembly mechanism can optionally be configured to operatively secure the second package 66 to the initial package 42 to provide a further combined package. Such a second package 66 can be directly or indirectly attached to the initial package 36. For example, the second package may be directly attached to the initial package 36 or directly attached to the previously combined first package 42. Alternatively, any of the combined packages may be combined with any fourth package 58 in order to provide for a yet further combined package 68 comprising any combination of first package, second package, third package, fourth package, and combinations thereof at a fourth packaging station 70.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for increasing sales of co-packaged occasion-based products, said method comprising the steps of:
determining an occasion;
identifying a consumer need/habit/practice for said occasion;
identifying occasion-based products that meet said consumer need/habit/practice; and,
co-packaging said identified occasion-based products that meet said consumer need/habit/practice into a package.

2. The method according to claim 1 wherein said package comprises at least two of said occasion-based products.

3. The method according to claim 2 wherein one of said at least two occasion-based products is a web-based substrate.

4. The method according to claim 3 wherein said web-based substrate is an absorbent tissue towel product.

5. The method according to claim 1 wherein said occasion is the cold/flu season.

6. The method according to claim 5 wherein one of said occasion-based product is selected from the group consisting of hand-sanitizing agents, medicaments, food stuffs, and combinations thereof.

7. The method according to claim 6 wherein a second of said occasion-based products is an absorbent tissue towel product.

8. The method according to claim 1 wherein said occasion is back-to-school.

9. The method according to claim 8 wherein a first of said occasion-based products is selected from the group consisting of hand-sanitizing agents, writing instruments, food stuffs, medicaments, and combinations thereof.

10. The method according to claim 9 wherein a second of said occasion-based products is an absorbent tissue towel product.

11. The method according to claim 1 wherein said step of identifying a consumer need/habit/practice for said occasion further comprises the step of identifying solutions to meet said consumer need/habit/practice for said occasion.

12. The method according to claim 11 wherein said step of identifying solutions to meet said consumer need/habit/practice for said occasion further comprises the steps of:
researching a known product or item usage by said consumer for said occasion;
identifying a concept that meets said consumer need/habit/practice for said occasion; and
evaluating said concept.

13. The method according to claim 1 further comprising the step of providing said package for sale.

14. A method for increasing sales of co-packaged occasion-based products, said method comprising the steps of:
identifying a consumer need/habit/practice for an occasion;
identifying solutions to meet said consumer need/habit/practice; and, co-packaging said identified solutions that meet said consumer need/habit/practice for said occasion into a package.

15. The method according to claim 14 further comprising the step of determining said occasion.

16. The method according to claim 15 wherein said occasion is selected from the group consisting of illnesses, allergies, party planning, tail-gate partying, weddings, evenings out, picnics, baptisms, funerals, graduations, entertaining, recreation, vacations, holidays, cold season, influenza season, allergy season, back-to-school season, and combinations thereof.

17. The method according to claim 14 wherein said step of identifying solutions to meet said consumer need/habit/practice further comprises the step of identifying products to meet said consumer need/habit/practice.

18. The method according to claim 17 wherein said step of co-packaging said identified solutions that meet said consumer need/habit/practice for said occasion into a package further comprises the step of co-packaging a plurality of said identified products into a package.

19. The method according to claim 17 wherein one of said plurality of identified products is a web-based substrate.

20. The method according to claim 13 wherein said step of identifying solutions to meet said consumer need/habit/practice further comprises the steps of:
researching a known product or item usage by said consumer for said occasion;
identifying a concept that meets said consumer need/habit/practice for said occasion; and
evaluating said concept.
